(19) United States
(12) Patent Application Publication
(10) Pub. No.: US 2022/0090604 A1
(43) Pub. Date: Mar. 24, 2022

(54) PUMP MONITORING APPARATUS, VACUUM PUMP, PUMP MONITORING METHOD, AND STORAGE MEDIUM STORING PUMP MONITORING PROGRAM

(71) Applicant: SHIMADZU CORPORATION, Kyoto (JP)

(72) Inventor: Kiyonori HIROTA, Kyoto (JP)

(21) Appl. No.: 17/377,433

(22) Filed: Jul. 16, 2021

(30) Foreign Application Priority Data
Sep. 23, 2020 (JP) 2020-158224

(51) Int. Cl. F04D 27/00; F04D 25/06

(52) U.S. Cl. CPC F04D 27/001; F04D 25/06

(57) ABSTRACT

A pump monitoring apparatus comprises a computer. The computer includes a processor and a memory, and the computer executes; a waveform data acquisition section configured to acquire waveform data of a physical quantity indicating an operation state of a vacuum pump; a feature quantity acquisition section configured to acquire a feature quantity of the waveform data; a first mechanical learning section configured to cluster the waveform data based on the feature quantity; a second mechanical learning section configured to read a time-series data group of the clustered waveform data to output predicted waveform data; and an information providing section configured to provide information regarding replacement or maintenance of the vacuum pump based on the predicted waveform data.

### BACKGROUND OF THE INVENTION

### 1. Technical Field

The present invention relates to a pump monitoring apparatus, a vacuum pump, a pump monitoring method, and a pump monitoring program.

### 2. Background Art

A step in manufacturing of a semiconductor, a liquid crystal panel and the like, such as dry etching or chemical vapor deposition (CVD), is executed in a vacuumed process chamber. Process gas is injected into the process chamber from which gas has been discharged by a vacuum pump. These steps are executed in a state in which the inside of the process chamber is maintained at a predetermined pressure. At the step such as dry etching or CVD, when the gas is discharged from the process chamber, a reaction product is accumulated in the vacuum pump in association with discharging of the gas in some cases.

Patent Literature 1 (JP-A-2020-41455) discloses a technique relating to a pump monitoring apparatus. The pump monitoring apparatus acquires waveform data of a current value of a vacuum pump, and based on the degree of matching between actual measurement waveform data and reference waveform data, determines an abnormality due to an increase in the load of the vacuum pump.

Utilizing the pump monitoring apparatus of Patent Literature 1, the abnormality of the vacuum pump can be determined. However, due to a mechanism in which occurrence of the abnormality in the vacuum pump is determined, such a technique fails to protect the vacuum pump in some cases. Depending on conditions, a defect might be caused in a vacuum pumping system.

### SUMMARY OF THE INVENTION

An object of the present invention is to predict an abnormality of a vacuum pump to provide a user with information regarding replacement or maintenance of the vacuum pump in advance.

A pump monitoring apparatus comprises a computer. The computer includes a processor and a memory, and the computer executes; a waveform data acquisition section configured to acquire waveform data of a physical quantity indicating an operation state of a vacuum pump; a feature quantity acquisition section configured to acquire a feature quantity of the waveform data; a first mechanical learning section configured to cluster the waveform data based on the feature quantity; a second mechanical learning section configured to read a time-series data group of the clustered waveform data to output predicted waveform data; and an information providing section configured to provide information regarding replacement or maintenance of the vacuum pump based on the predicted waveform data.

The information regarding replacement or maintenance includes the remaining number of times of use of a process for the vacuum pump.

The information regarding replacement or maintenance includes a remaining use time of the vacuum pump.

The computer further executes; an alerting section configured to issue an alert in a case where it is, using the information regarding replacement or maintenance, determined that the vacuum pump is in a state requiring replacement or maintenance.

The predicted waveform data and actual measurement waveform data are compared to each other, and the second mechanical learning section performs learning such that a difference between the predicted waveform data and the actual measurement waveform data is decreased.

The first mechanical learning section clusters the actual measurement waveform data by means of k-means clustering or a self organizing map (SOM).

The second mechanical learning section reads the time-series data group of the clustered waveform data together with a clustering information and a time information, and performs regression analysis for the time-series data group of the clustered waveform data.

The feature quantity acquisition section acquires variance value of the waveform data as the feature quantity.

If it is assumed that the waveform data for a single process is sampling data for n points, the feature quantity acquisition section acquires the variance value of values X1, X2, . . . Xn of the waveform data at the n points.

The physical quantity is motor current value.

A vacuum pump comprises: the pump monitoring apparatus.

A pump monitoring method comprises: a step of acquiring waveform data of a physical quantity indicating an operation state of a vacuum pump; a step of acquiring a feature quantity of the waveform data; a step of clustering the waveform data based on the feature quantity; a step of reading a time-series data group of the clustered waveform data to output predicted waveform data; and a step of providing information regarding replacement or maintenance of the vacuum pump based on the predicted waveform data.

A storage medium for storing a pump monitoring program causing a computer to execute a processing of acquiring waveform data of a physical quantity indicating an operation state of a vacuum pump, a processing of acquiring a feature quantity of the waveform data, a processing of clustering the waveform data based on the feature quantity, a processing of reading a time-series data group of the clustered waveform data to output predicted waveform data, and a processing of providing information regarding replacement or maintenance of the vacuum pump based on the predicted waveform data.

According to the present invention, the abnormality of the vacuum pump can be predicted, and the information regarding replacement or maintenance of the vacuum pump can be provided to the user in advance.

### BRIEF DESCRIPTION OF THE DRAWINGS

FIG. 1 is a schematic diagram of a vacuuming apparatus according to the present embodiment;

FIG. 2 is a sectional view of a vacuum pump according to the present embodiment;

FIG. 3 is a functional block diagram of a pump controller and a pump monitoring apparatus according to the present embodiment;

FIG. 4 is a graph showing actual measurement waveform data of a motor current value;

FIG. 5 is a flowchart showing a first mechanical learning method according to the present embodiment;

FIG. 6 is a flowchart showing a second mechanical learning method according to the present embodiment;

FIG. 7 is a flowchart showing a pump replacement information providing method according to the present embodiment; and

FIG. 8 is a configuration diagram of a pump monitoring apparatus according to the present embodiment.

### DETAILED DESCRIPTION OF THE EXEMPLARY EMBODIMENTS

Next, the configurations of a pump monitoring apparatus and a vacuum pump according to an embodiment of the present invention will be described with reference to the attached drawings.

### (1) Configuration of Vacuuming Apparatus

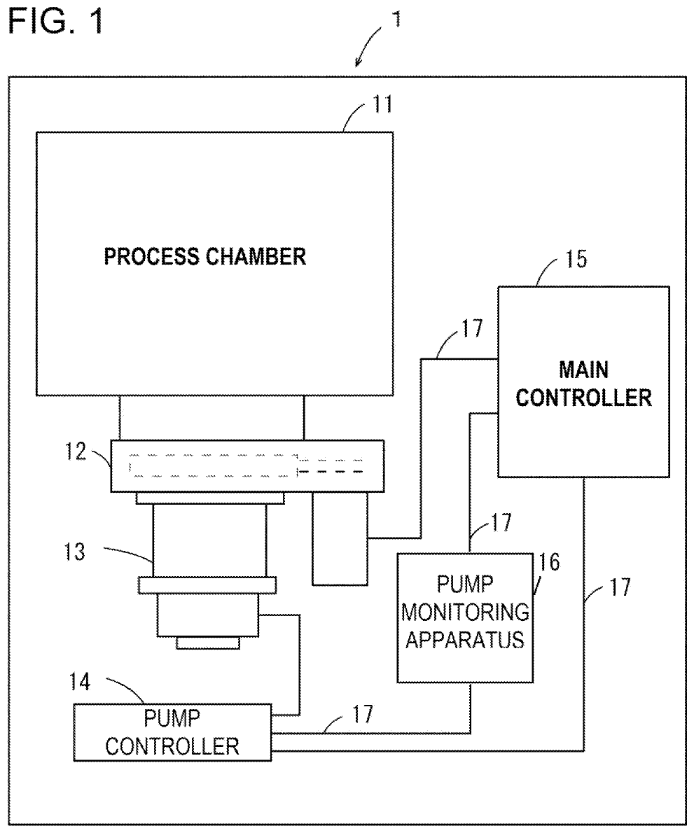

FIG. 1 is an entire diagram of a vacuuming apparatus 1 equipped with the pump monitoring apparatus 16 of the embodiment. The vacuuming apparatus 1 is, for example, an etching apparatus or a film formation apparatus. As shown in FIG. 1, the vacuuming apparatus 1 includes a process chamber 11, a valve 12, the vacuum pump 13, a pump controller 14, a main controller 15, and the pump monitoring apparatus 16.

The vacuum pump 13 is attached to the process chamber 11 via the valve 12. The pump controller 14 drivably controls the vacuum pump 13. The pump monitoring apparatus 16 configured to monitor the state of the vacuum pump 13 is connected to the pump controller 14. Note that in an example shown in FIG. 1, the single pump controller 14 is connected to the pump monitoring apparatus 16, but the pump monitoring apparatus 16 may be connected to multiple pump controllers 14 to monitor multiple vacuum pumps 13.

The main controller 15 controls the entirety of the vacuuming apparatus 1 including the vacuum pump 13. The valve 12, the pump controller 14, and the pump monitoring apparatus 16 are connected to the main controller 15 via a communication line 17. The pump monitoring apparatus 16 monitors a physical quantity indicating an operation state of the vacuum pump 13 to predict an abnormality of the vacuum pump 13. An example of the pump abnormality in the present specification is a case where the amount of reaction product accumulated in the vacuum pump 13 exceeds an acceptable amount.

Note that the configuration of the vacuuming apparatus 1 shown in FIG. 1 is one example. For example, the vacuum pump 13 may include the pump controller 14 and the pump monitoring apparatus 16.

### (2) Configuration of Vacuum Pump

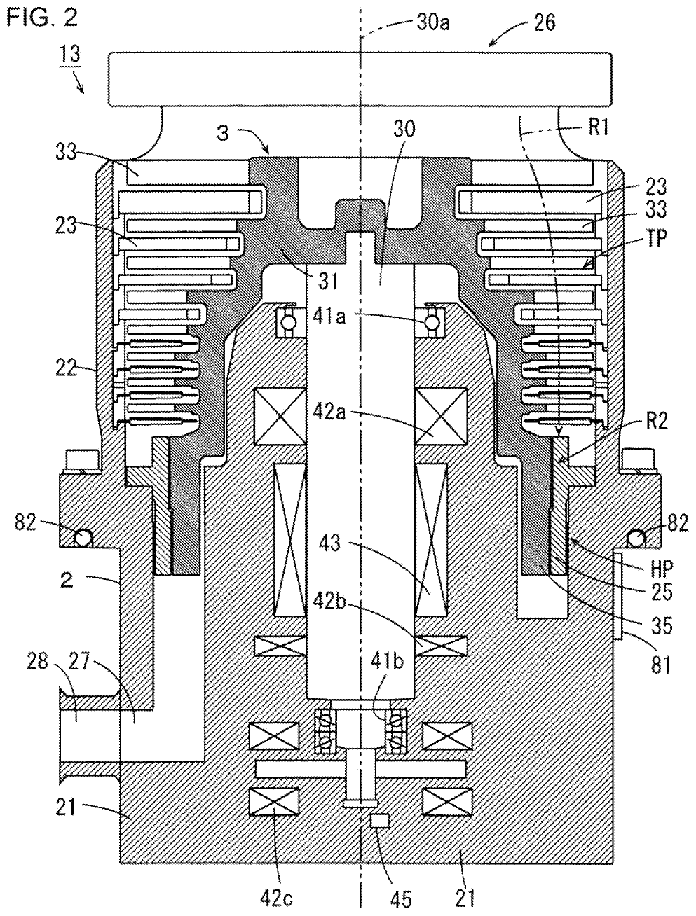

FIG. 2 is a sectional view showing the configuration of the vacuum pump 13. The vacuum pump 13 in the present embodiment is a magnetic bearing type turbo-molecular pump. The vacuum pump 13 includes a rotary body 3 having a rotor shaft 30, a pump rotor 31, rotor blades 33, and a rotor cylindrical portion 35 and a rotation support portion 2 having a base 21, a pump case 22, stator blades 23, and a stator 25. The rotor shaft 30 is rotatably driven by a motor 43, thereby integrally rotating the rotary body 3 relative to the rotation support portion 2. The rotor shaft 30 is rotatably driven about a shaft center 30a.

At the pump rotor 31, the multiple stages of the rotor blades 33 are formed on an upstream side, and the rotor cylindrical portion 35 is formed on a downstream side. Corresponding to these components, the multiple stages of the stator blades 23 and the cylindrical stator 25 are provided on a fixed side. The multiple rotor blades 33 and the multiple stator blades 23 are alternately arranged with clearances in an upper-lower direction, thereby forming a turbopump TP. A region passing through the multiple rotor blades 33 and the multiple stator blades 23 in the upper-lower direction forms a flow path R1. A not-shown screw groove is formed at either of the rotor cylindrical portion 35 or the stator 25. The rotor cylindrical portion 35 and the stator 25 form a Holweck pump HP. A minute clearance formed between the rotor cylindrical portion 35 and the stator 25 forms a flow path R2.

The rotor shaft 30 is magnetically levitated and supported by radial magnetic bearings 42a, 42b and an axial magnetic bearing 42c provided at the base 21, and is rotatably driven by the motor 43. Each of the magnetic bearings 42a to 42c includes an electromagnet and a displacement sensor, and the levitation position of the rotor shaft 30 is detected by the displacement sensors. The rotation number of the rotor shaft 30 is detected by a rotation number sensor 45. In a case where the magnetic bearings 42a to 42c are not in operation, the rotor shaft 30 is supported by emergency mechanical bearings 41a, 41b.

The tubular pump case 22 forming the outer shape of the vacuum pump 13 is fixed to an upper portion of the base 21. A suction opening 26 is formed at an upper end of the pump case 22. The suction opening 26 is connected to the process chamber 11 via the valve 12. An exhaust port 28 is provided at an exhaust opening 27 of the base 21, and an auxiliary pump is connected to the exhaust port 28. When the rotor shaft 30 to which the pump rotor 31 is fastened is rotated at high speed by the motor 43, gas molecules on a suction opening 26 side flow in the flow path R1 and the flow path R2, and are discharged through the exhaust port 28.

A heater 81 and a refrigerant pipe 82 in which refrigerant such as coolant water flows are provided at the base 21. A not-shown refrigerant supply pipe is connected to the refrigerant pipe 82. By the control of opening/closing an electromagnetic on-off valve provided at the refrigerant supply pipe, the flow rate of refrigerant supplied to the refrigerant pipe 82 is adjusted. In a case where gas which is likely to cause accumulation of the reaction product in the vacuum pump 13 is discharged, temperature adjustment is performed to reduce product accumulation on a screw groove pump portion and downstream ones of the rotor blades 33. Specifically, by ON/OFF of the heater 81 and ON/OFF of the flow rate of refrigerant flowing in the refrigerant pipe 82, temperature adjustment is performed such that a base temperature in the vicinity of a stator fixed portion reaches a predetermined temperature, for example.

### (3) Configurations of Pump Controller and Pump Monitoring Apparatus

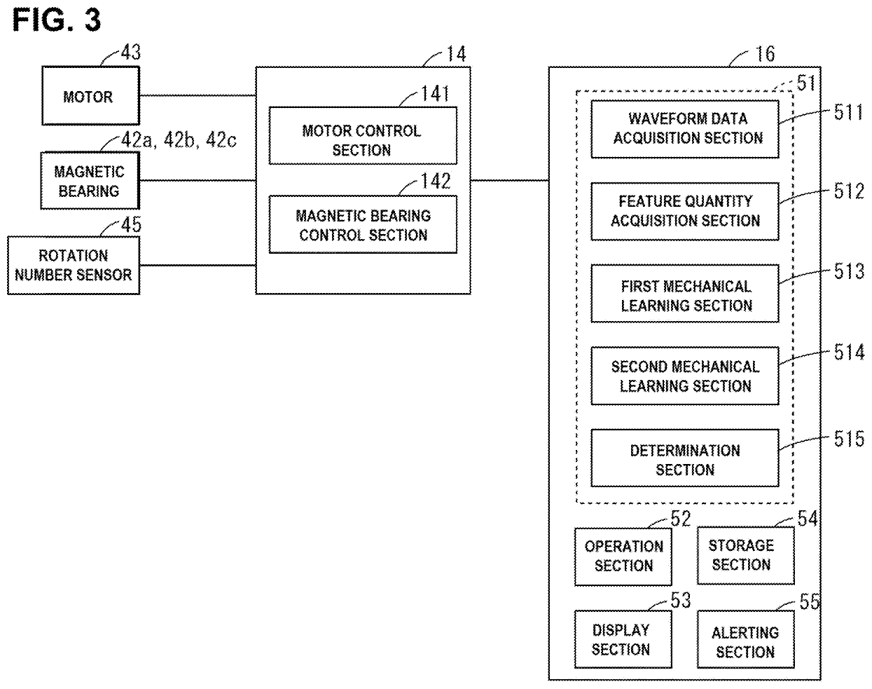

FIG. 3 is a functional block diagram showing the configurations of the pump controller 14 and the pump monitoring apparatus 16. As also shown in FIG. 2, the vacuum pump 13 includes the motor 43, the magnetic bearings 42a, 42b, 42c, and the rotation number sensor 45. The motor 43, the magnetic bearings 42a, 42b, 42c, and the rotation number sensor 45 are controlled by the pump controller 14. The pump controller 14 includes a motor control section 141 and a magnetic bearing control section 142.

The motor control section 141 estimates the rotation number of the rotor shaft 30 based on a rotation signal detected by the rotation number sensor 45, and feedback-controls the motor 43 to a predetermined target rotation number based on the estimated rotation number. As a gas flow rate increases, the load of the pump rotor 31 increases, and the rotation number of the motor 43 decreases accordingly. The motor control section 141 controls a motor current such that a difference between the rotation number detected by the rotation number sensor 45 and the predetermined target rotation number reaches zero, and in this manner, the predetermined target rotation number (a rated rotation number) is maintained. As described above, in a state in which a series of processes is performed, the motor control section 141 performs the steady-state operation control of maintaining a rotation speed at a rated rotation speed. The magnetic bearings 42a to 42c include the bearing electromagnets and the displacement sensors configured to detect the levitation position of the rotor shaft 30.

The pump monitoring apparatus 16 is an apparatus configured to monitor the state of the vacuum pump 13 attached to the process chamber 11. The pump monitoring apparatus 16 includes a control section 51, an operation section 52, a display section 53, a storage section 54, and an alerting section 55. The control section 51 includes a waveform data acquisition section 511, a feature quantity acquisition section 512, a first mechanical learning section 513, a second mechanical learning section 514, and a determination section 515. The operation section 52 receives user operation for the pump monitoring apparatus 16. The operation section 52 includes, for example, multiple operation buttons. The display section 53 is, for example, a liquid crystal display panel, and displays information regarding replacement or maintenance of the vacuum pump 13. The storage section 54 includes a random access memory (RAM), a read-only memory (ROM), a hard drive or the like. The alerting section 55 issues an alert when pump replacement timing or maintenance timing comes.

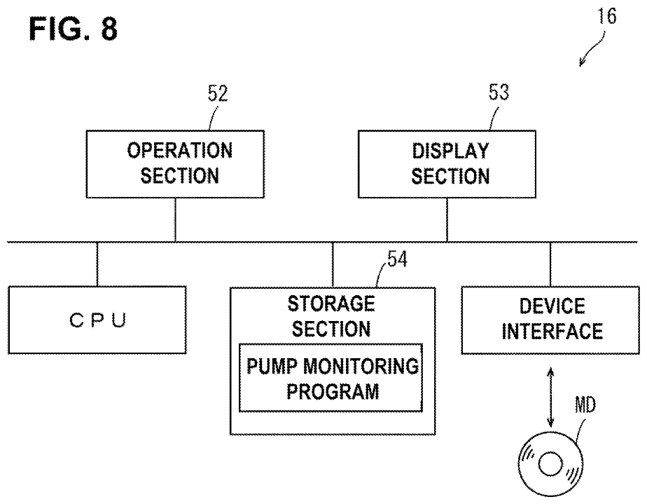

The pump monitoring apparatus 16 includes a CPU (see FIG. 8). The control section 51 is implemented in such a manner that the CPU uses the storage section 54 such as a RAM as a working memory and executes a pump monitoring program (see FIG. 8) stored in the storage section 54. That is, the waveform data acquisition section 511, the feature quantity acquisition section 512, the first mechanical learning section 513, the second mechanical learning section 514, and the determination section 515 are implemented in such a manner that the pump monitoring program stored in the storage section 54 is executed.

In the present embodiment, the motor current value of the vacuum pump 13 is used as a physical quantity indicating the operation state of the vacuum pump 13. The motor control section 141 of the pump controller 14 detects the motor current value. The waveform data acquisition section 511 of the pump monitoring apparatus 16 acquires the motor current value from the pump controller 14. The motor current value is acquired at a predetermined sampling interval set in advance. The waveform data acquisition section 511 generates actual measurement waveform data of the motor current value on the basis of the acquired motor current value.

### (4) Waveform Data for Each Process

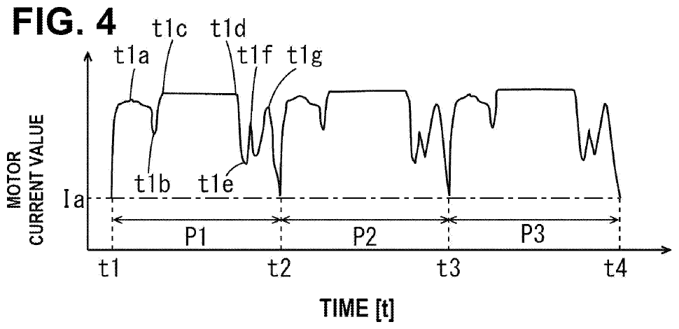

FIG. 4 is a graph showing the actual measurement waveform data of the motor current value when the same vacuuming process is continuously repeated in the vacuuming apparatus 1, e.g., an etching process is continuously repeated for multiple substrates. The process is performed for the first substrate in a period P1 between time points t1 to t2, is performed for the second substrate in a period P2 between the time points t2 to t3, and is performed for the third substrate in a period P3 between the time points t3 to t4. The same process is repeatedly performed, and therefore, the actual measurement waveform data of the motor current value has the substantially same waveform among the periods P1 to P3. Hereinafter, these periods P1 to P3 will be referred to as process periods.

At the time point t1, the first substrate is delivered into the process chamber 11, and air is discharged from the process chamber 11 by the vacuum pump 13. Accordingly, the motor current value rapidly increases, and reaches a local maximum value at a time point t1a. Subsequently, the motor current value decreases between the time points t1a to t1b. Subsequently, at the time point t1b, process gas is injected such that the motor current value increases again, and the motor current value reaches a high value at a time point t1c. The process is performed with a constant process pressure between the time points t1c to t1d, and therefore, the motor current value is substantially constant. At the time t1d, the process for the first substrate ends, and injection of the process gas is stopped. Accordingly, the motor current value rapidly decreases, and reaches a local minimum value at a time point t1e. Thereafter, the motor current value reaches local maximum values at time points t1f, t1g, rapidly decreases from the local maximum value at the time point t1g, and reaches a local minimum value at the time point t2. Meanwhile, the first substrate is delivered out, and the second substrate is delivered in. In the process period P2 starting for the second substrate from the time point t2 and the process period P3 starting for the third substrate from the time point t3, the motor current value shows a change similar to that in the process period P1.

In FIG. 4, it is assumed that rotation of the vacuum pump 13 is started and the first process is started at t=t1. During the process period, the motor current value reaches the local minimum value multiple times, and reaches the local minimum value (I≈Ia) as a smallest value at the time points t1, t2, t3, t4 . . . . This local minimum value I≈Ia is acquired at the start of each process period as shown in FIG. 4, and therefore, motor current value data for two process periods is sampled at the time of obtaining the local minimum value I≈Ia three times.

A single process period is a time Δt. A time interval at which the motor current value as the current value I≈Ia is acquired is equivalent to the time Δt of the single process period. Thus, a differential value between the time point of sampling of the (N+1)-th current value I≈Ia and the time point of sampling of the first current value I≈Ia is multiplied by 1/N, and in this manner, the time Δt of the single process period is calculated. The calculated time Δt of the single process period is stored in the storage section 54.

When Δt is calculated, data corresponding to the single process period is acquired from the motor current value data sampled and accumulated in the storage section 54, and in this manner, the actual measurement waveform data for the single process is generated.

The processing of acquiring the actual measurement waveform data is repeatedly executed until the vacuum pump 13 is stopped after a series of processes in the vacuuming apparatus 1 has been stopped. The actual measurement waveform data for the single process period is newly calculated every time the motor current value for the single process period is newly acquired, and is accumulated in the storage section 54.

### (5) First Mechanical Learning Processing

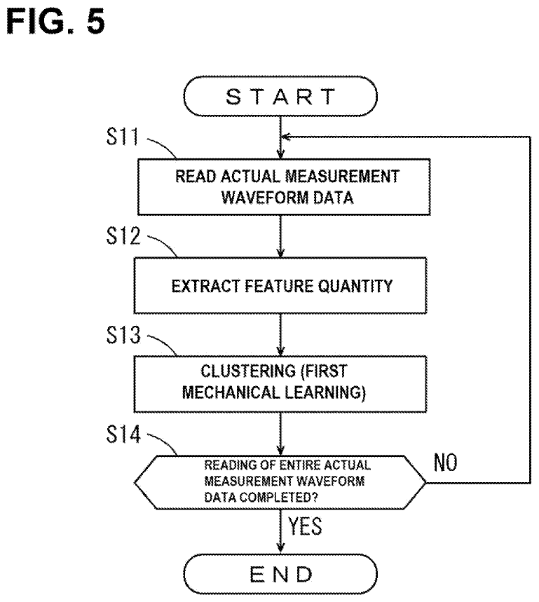

Next, first mechanical learning processing according to the present embodiment will be described. FIG. 5 is a flowchart of learning steps of the first mechanical learning processing executed in the waveform data acquisition section 511, the feature quantity acquisition section 512, and the first mechanical learning section 513. The processing shown in FIG. 5 is executed in such a manner that the pump monitoring program stored in the storage section 54 is executed.

At a step S11, the waveform data acquisition section 511 reads the actual measurement waveform data. As shown in FIG. 4, the actual measurement waveform data is the data of the motor current value corresponding to the single process period (the Δt time). The waveform data acquisition section 511 reads the actual measurement waveform data for the Δt time from the data of the motor current value sampled and stored in the storage section 54. The waveform data acquisition section 511 also acquires, together with the actual measurement waveform data, time information on acquisition of the actual measurement waveform data. The time information is information indicating a cumulative operation time from the start of use of the vacuum pump 13 for which the actual measurement waveform data is acquired.

Next, at a step S12, the feature quantity acquisition section 512 extracts the feature quantity of the waveform data read at the step S11. In the present embodiment, the feature quantity acquisition section 512 acquires the variance value of the actual measurement waveform data as the feature quantity. For example, it is assumed that the actual measurement waveform data for the single process is sampling data for n points, the feature quantity acquisition section 512 acquires the variance value of the values X1, X2, . . . Xn of the actual measurement waveform data at the n points.

Next, at a step S13, the first mechanical learning section 513 clusters the actual measurement waveform data based on the feature quantity acquired by the feature quantity acquisition section 512. The first mechanical learning section 513 clusters the actual measurement waveform data by means of, e.g., k-means clustering or a self organizing map (SOM). At a step S14, it is determined whether or not reading has been completed for the entire actual measurement waveform data targeted for the processing. In a case where reading of the entire actual measurement waveform data is not completed yet, the processing returns to the step S11 and is repeated. When reading of the entire actual measurement waveform data is completed, the first mechanical learning processing shown in FIG. 5 ends.

Multiple pieces of the actual measurement waveform data are learnt by the first mechanical learning section 513 as described above, and in this manner, the actual measurement waveform data of the motor current value as the physical quantity indicating the operation state of the vacuum pump 13 is clustered. For enhancing learning accuracy, the actual measurement waveform data is preferably learnt by execution of various processes in the vacuum pump 13. Moreover, many pieces of the actual measurement waveform data are preferably learnt by utilization of multiple different vacuum pumps 13.

### (6) Second Mechanical Learning Processing

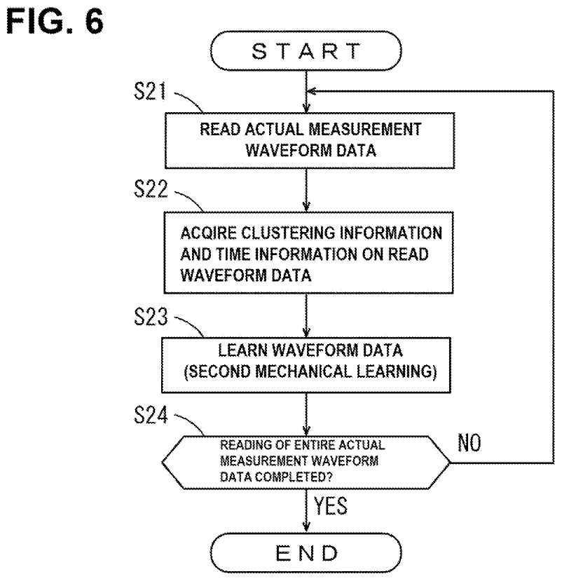

Next, second mechanical learning processing according to the present embodiment will be described. FIG. 6 is a flowchart of learning steps of the second mechanical learning processing executed in the second mechanical learning section 514. The processing shown in FIG. 6 is executed in such a manner that the pump monitoring program stored in the storage section 54 is executed.

First, the actual measurement waveform data clustered at a step S21 is read. Next, at a step S22, clustering information and the time information on the actual measurement waveform data read at the step S21 are acquired. The clustering information is information indicating the result of clustering in the first mechanical learning section 513. For example, an ID is provided as the clustering information to each piece of the actual measurement waveform data. The time information is information indicating the time at which the actual measurement waveform data is acquired. As described above, the time information is the information indicating the cumulative operation time from the start of use of the vacuum pump 13 for which the actual measurement waveform data is acquired.

Subsequently, at a step S23, the second mechanical learning section 514 reads the actual measurement waveform data together with the clustering information and the time information, and performs regression analysis for the actual measurement waveform data. The actual measurement waveform data read by the second mechanical learning section 514 holds the time information in units of clustered group. That is, the actual measurement waveform data is a time-series data group of clustered groups. The second mechanical learning section 514 reads the time-series data group of the actual measurement waveform data, and obtains a regression expression for each clustered group. At a step S24, it is determined whether or not reading has been completed for the entire actual measurement waveform data targeted for the processing. In a case where reading of the entire actual measurement waveform data is not completed yet, the processing returns to the step S21 and is repeated. When reading of the entire actual measurement waveform data is completed, the second mechanical learning processing shown in FIG. 6 ends.

Multiple pieces of the actual measurement waveform data are learnt by the second mechanical learning section 514 as described above, and in this manner, regression analysis is performed for the actual measurement waveform data of the motor current value as the physical quantity indicating the operation state of the vacuum pump 13. For enhancing learning accuracy, the actual measurement waveform data is preferably learnt by execution of various processes in the vacuum pump 13. Moreover, many pieces of the actual measurement waveform data are preferably learnt by utilization of multiple different vacuum pumps 13.

### (7) Pump Replacement Information Providing Processing

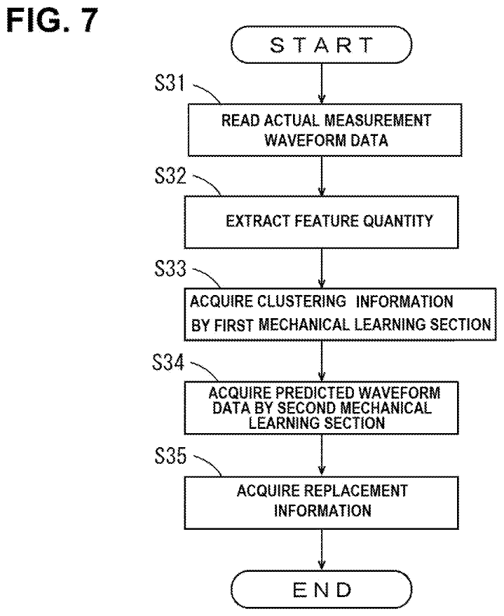

Next, pump replacement information providing processing according to the present embodiment will be described. FIG. 7 is a flowchart of the pump replacement information providing processing executed in the waveform data acquisition section 511, the feature quantity acquisition section 512, the first mechanical learning section 513, and the second mechanical learning section 514. The processing shown in FIG. 7 is executed in such a manner that the pump monitoring program stored in the storage section 54 is executed. After learning by the first mechanical learning section 513 and the second mechanical learning section 514 has been completed by the processing of FIGS. 5 and 6, the processing of FIG. 7 is executed. That is, the processing shown in FIG. 7 is the processing of predicting the operation state of the vacuum pump 13 by utilizing the first mechanical learning section 513 and the second mechanical learning section 514 as a learned model.

At a step S31, the waveform data acquisition section 511 reads the actual measurement waveform data. As shown in FIG. 4, the actual measurement waveform data is the data of the motor current value corresponding to the single process period (the Δt time). The waveform data acquisition section 511 also acquires the time information on acquisition of the actual measurement waveform data together with the actual measurement waveform data. Next, at a step S32, the feature quantity acquisition section 512 extracts the feature quantity of the actual measurement waveform data read at the step S31. In the present embodiment, the feature quantity acquisition section 512 acquires the variance value of the actual measurement waveform data as the feature quantity.

Next, at a step S33, the first mechanical learning section 513 clusters the actual measurement waveform data based on the feature quantity acquired by the feature quantity acquisition section 512. In this manner, the clustering information of the read actual measurement waveform data is acquired.

Next, at a step S34, the clustered actual measurement waveform data is read. At this point, the clustering information and the time information on the read actual measurement waveform data are input together to the second mechanical learning section 514. Thus, the second mechanical learning section 514 reads the actual measurement waveform data together with the clustering information and the time information, and outputs predicted waveform data of the actual measurement waveform data. For example, the second mechanical learning section 514 outputs predicted waveform data of a future motor current value after the process has been executed once to m times. That is, based on the actual measurement waveform data read by the second mechanical learning section 514, the predicted waveform data obtained after the process has been further executed once, the predicted waveform data obtained after the process has been executed twice, the predicted waveform data obtained after the process has been executed three times, . . . , and the predicted waveform data obtained after the process has been executed m times are output.

Next, at a step S35, the determination section 515 compares a value calculated based on the predicted waveform data and a threshold to acquire pump replacement suggestion information. For example, as the threshold, a current maximum value difference or a current average difference between the actual measurement waveform data and the predicted waveform data can be used. For example, when a difference between the maximum or average current value of the k-th (k is an integer of equal to or greater than 1 and equal to or less than m) predicted waveform data and the maximum or average current value of the actual measurement waveform data exceeds the threshold, the determination section 515 determines that the pump replacement timing for the vacuum pump 13 comes after execution of the k-th process. Alternatively, the degree of waveform matching between the actual measurement waveform data and the predicted waveform data can be used as the threshold. For example, when the degree of waveform matching between the k-th (k is an integer of equal to or greater than 1 and equal to or less than m) predicted waveform data and the actual measurement waveform data falls below the threshold, the determination section 515 determines that the pump replacement timing for the vacuum pump 13 comes after execution of the k-th process.

When the determination section 515 determines, using the k-th predicted waveform data, that the replacement timing for the vacuum pump 13 comes, the determination section 515 provides the display section 53 with information indicating the necessity of pump replacement. For example, the determination section 515 provides the remaining number of times of use of the process as the pump replacement suggestion information. For example, in a case where it is, using the k-th predicted waveform data, determined that the replacement timing comes, the determination section 515 provides the number of times less than k as the remaining number of times of use. Alternatively, the determination section 515 provides, for example, a remaining use time as the pump replacement suggestion information. For example, in a case where it is, using the k-th predicted waveform data, determined that the replacement timing comes, the determination section 515 provides a time less than a time for k processes as the remaining use time. For example, Δt can be used as a single process time. In a case where various processes are executed, the average time of Δt may be used.

In a case where the determination section 515 determines that the vacuum pump 13 is in a state requiring replacement, such as a state in which the remaining number of times of use reaches zero or the remaining use time reaches zero, the determination section 515 notifies the alerting section 55 of information indicating that the vacuum pump needs to be replaced. Alternatively, in a case where the remaining number of times of use falls below a predetermined number of times such as one or the remaining use time falls below a predetermined time such as 10 minutes, the determination section 515 may notify the alerting section 55 of replacement necessity information. In this manner, the alerting section 55 issues an alert. Moreover, the alerting section 55 notifies the main controller 15 to transition to a protection mode such as stop of operation of the vacuum pump 13.

### (8) Correspondence Between Each Component of Claims and Each Element of Embodiment

Hereinafter, an example of a correspondence between each component of the claims and each element of the embodiment will be described, but the present invention is not limited to the following example. In the above-described embodiment, the determination section 515 and the display section 53 are an example of an information providing section. Moreover, in the above-described embodiment, the actual measurement waveform data is an example of waveform data.

Various elements having configurations or functions described in claims can be also used as each component of the claims.

### (9) Other Embodiments

In the above-described embodiment, the pump replacement suggestion information is displayed on the display section 53 included in the pump monitoring apparatus 16. As other embodiments, the display section configured to display the pump replacement suggestion information may be provided separately from the pump monitoring apparatus 16. Alternatively, the entire configuration of the pump monitoring apparatus 16 including the display section 53 may be incorporated into the pump controller 14. Alternatively, the pump replacement suggestion information may be provided to a display section of the main controller 15. Alternatively, the pump replacement suggestion information may be displayed on a screen of a computer connected to the vacuuming apparatus 1.

In the above-described embodiment, the motor current value of the vacuum pump 13 is used as the physical quantity indicating the operation state of the vacuum pump 13. As other physical quantities indicating the operation state of the vacuum pump 13, the rotation number, temperature, rotary shaft shift amount or the like of the vacuum pump 13 can be used. These physical quantities can be acquired from a rotation number sensor, a temperature sensor, a displacement sensor or the like provided at the vacuum pump 13.

In the above-described embodiment, the variance value of the waveform data of the motor current value is used as the feature quantity of the physical quantity indicating the operation state of the vacuum pump 13. As other feature quantities, the waveform shape, waveform derivative value or the like of the waveform data of the motor current value can be used. Similarly, in a case where the other physical quantities such as the rotation number, temperature, or rotary shaft shift amount of the vacuum pump 13 are used as the physical quantity, the variance value, waveform shape, or waveform derivative value of the waveform data of such a physical quantity can be used.

In the above-described embodiment, the case where the pump monitoring program is saved in the storage section 54 has been described. As other embodiments, the pump monitoring program may be saved and provided in a storage medium MD. FIG. 8 is a configuration diagram of the pump monitoring apparatus 16. The CPU of the pump monitoring apparatus 16 may access to the storage medium MD via a device interface, thereby saving, in the storage section 54, the pump monitoring program saved in the storage medium MD. Alternatively, the CPU may access to the storage medium MD via the device interface, thereby executing the pump monitoring program saved in the storage medium MD.

In the above-described embodiment, the second mechanical learning section 514 outputs the predicted waveform data. For example, the second mechanical learning section 514 outputs the predicted waveform data for future m processes. As other embodiments, the pump monitoring apparatus 16 may perform the processing of comparing the actual measurement waveform data and the predicted waveform data. Moreover, the pump monitoring apparatus 16 may further proceed learning of the second mechanical learning section 514 so that the difference between the actual measurement waveform data and the predicted waveform data can be decreased. For example, learning of the second mechanical learning section 514 may be proceeded so that the degree of matching between the actual measurement waveform data and the predicted waveform data can be improved.

In the above-described embodiment, it is configured such that the actual measurement waveform data is learnt by the first mechanical learning section 513 and the second mechanical learning section 514. As other embodiments, it may be configured such that reference waveform data obtained by processing of the actual measurement waveform data is learnt. For example, the reference waveform data can be generated using the average of the current values of the actual measurement waveform data for 10 processes at the same sampling point. It may be configured such that multiple pieces of the reference waveform data are acquired and are learnt by the first mechanical learning section 513 and the second mechanical learning section 514.

Note that the specific configurations of the present invention are not limited to those of the above-described embodiment, and various changes and corrections can be made without departing from the gist of the present invention.

### (10) Aspects

Those skilled in the art understand that the above-described multiple exemplary embodiments are specific examples of the following aspects.

A pump monitoring apparatus comprises a computer. The computer includes a processor and a memory, and the computer executes; a waveform data acquisition section configured to acquire waveform data of a physical quantity indicating an operation state of a vacuum pump; a feature quantity acquisition section configured to acquire a feature quantity of the waveform data; a first mechanical learning section configured to cluster the waveform data based on the feature quantity; a second mechanical learning section configured to read a time-series data group of the clustered waveform data to output predicted waveform data; and an information providing section configured to provide information regarding replacement or maintenance of the vacuum pump based on the predicted waveform data.

The information regarding replacement or maintenance includes the remaining number of times of use of a process for the vacuum pump.

The information regarding replacement or maintenance includes a remaining use time of the vacuum pump.

The computer further executes; an alerting section configured to issue an alert in a case where it is, using the information regarding replacement or maintenance, determined that the vacuum pump is in a state requiring replacement or maintenance.

The predicted waveform data and actual measurement waveform data are compared to each other, and the second mechanical learning section performs learning such that a difference between the predicted waveform data and the actual measurement waveform data is decreased.

The first mechanical learning section clusters the actual measurement waveform data by means of k-means clustering or a self organizing map (SOM).

The second mechanical learning section reads the time-series data group of the clustered waveform data together with a clustering information and a time information, and performs regression analysis for the time-series data group of the clustered waveform data.

The feature quantity acquisition section acquires variance value of the waveform data as the feature quantity.

If it is assumed that the waveform data for a single process is sampling data for n points, the feature quantity acquisition section acquires the variance value of values X1, X2, . . . Xn of the waveform data at the n points.

The physical quantity is motor current value.

A vacuum pump comprises: the pump monitoring apparatus.

A pump monitoring method comprises: a step of acquiring waveform data of a physical quantity indicating an operation state of a vacuum pump; a step of acquiring a feature quantity of the waveform data; a step of clustering the waveform data based on the feature quantity; a step of reading a time-series data group of the clustered waveform data to output predicted waveform data; and a step of providing information regarding replacement or maintenance of the vacuum pump based on the predicted waveform data.

A storage medium for storing a pump monitoring program causing a computer to execute a processing of acquiring waveform data of a physical quantity indicating an operation state of a vacuum pump, a processing of acquiring a feature quantity of the waveform data, a processing of clustering the waveform data based on the feature quantity, a processing of reading a time-series data group of the clustered waveform data to output predicted waveform data, and a processing of providing information regarding replacement or maintenance of the vacuum pump based on the predicted waveform data.

What is claimed is:

1. A pump monitoring apparatus comprising a computer, wherein the computer includes a processor and a memory, and the computer executes;
a waveform data acquisition section configured to acquire waveform data of a physical quantity indicating an operation state of a vacuum pump;
a feature quantity acquisition section configured to acquire a feature quantity of the waveform data;
a first mechanical learning section configured to cluster the waveform data based on the feature quantity;
a second mechanical learning section configured to read a time-series data group of the clustered waveform data to output predicted waveform data; and
an information providing section configured to provide information regarding replacement or maintenance of the vacuum pump based on the predicted waveform data.

2. The pump monitoring apparatus according to claim 1, wherein
the information regarding replacement or maintenance includes the remaining number of times of use of a process for the vacuum pump.

3. The pump monitoring apparatus according to claim 1, wherein
the information regarding replacement or maintenance includes a remaining use time of the vacuum pump.

4. The pump monitoring apparatus according to claim 1, wherein:
the computer further executes;
an alerting section configured to issue an alert in a case where it is, using the information regarding replacement or maintenance, determined that the vacuum pump is in a state requiring replacement or maintenance.

5. The pump monitoring apparatus according to claim 1, wherein
the predicted waveform data and actual measurement waveform data are compared to each other, and the second mechanical learning section performs learning such that a difference between the predicted waveform data and the actual measurement waveform data is decreased.

6. The pump monitoring apparatus according to claim 1, wherein
the first mechanical learning section clusters the actual measurement waveform data by means of k-means clustering or a self organizing map (SOM).

7. The pump monitoring apparatus according to claim 1, wherein
the second mechanical learning section reads the time-series data group of the clustered waveform data together with a clustering information and a time information, and performs regression analysis for the time-series data group of the clustered waveform data.

8. The pump monitoring apparatus according to claim 1, wherein
the feature quantity acquisition section acquires variance value of the waveform data as the feature quantity.

9. The pump monitoring apparatus according to claim 8, wherein
if it is assumed that the waveform data for a single process is sampling data for n points, the feature quantity acquisition section acquires the variance value of values X1, X2, . . . Xn of the waveform data at the n points.

10. The pump monitoring apparatus according to claim 1, wherein
the physical quantity is motor current value.

11. A vacuum pump comprising:
the pump monitoring apparatus according to claim 1.

12. A pump monitoring method comprising:
a step of acquiring waveform data of a physical quantity indicating an operation state of a vacuum pump;
a step of acquiring a feature quantity of the waveform data;
a step of clustering the waveform data based on the feature quantity;
a step of reading a time-series data group of the clustered waveform data to output predicted waveform data; and
a step of providing information regarding replacement or maintenance of the vacuum pump based on the predicted waveform data.

13. A storage medium for storing a pump monitoring program causing a computer to execute
a processing of acquiring waveform data of a physical quantity indicating an operation state of a vacuum pump,
a processing of acquiring a feature quantity of the waveform data,
a processing of clustering the waveform data based on the feature quantity,
a processing of reading a time-series data group of the clustered waveform data to output predicted waveform data, and
a processing of providing information regarding replacement or maintenance of the vacuum pump based on the predicted waveform data.
